(19) United States
(12) Patent Application Publication
(10) Pub. No.: US 2012/0099624 A1
(43) Pub. Date: Apr. 26, 2012

(54) COMMUNICATION DEVICE AND METHOD OF REDUCING HARMONICS TRANSMITTED

(75) Inventors: Setsuya NAGAYA, Kawasaki (JP); Akio Sasaki, Kawasaki (JP); Narito Matsuno, Kawasaki (JP); Kenji Iwai, Kawasaki (JP); Shinichi Kawai, Kawasaki (JP)

(73) Assignee: FUJITSU LIMITED, Kawasaki-shi (JP)

(21) Appl. No.: 13/180,590

(22) Filed: Jul. 12, 2011

(30) Foreign Application Priority Data
Oct. 26, 2010 (JP) 2010-240177

(51) Int. Cl. H04B 1/38

(52) U.S. Cl. 375/219

(57) ABSTRACT

A communication device includes a transmitting circuit that includes a quadrature modulator; a receiving circuit that operates as a quadrature demodulator that, when being in a data non-transferring period, starts when power is switched on and ends when receiving operation starts, switches a local oscillator signal to a harmonic receiving signal, and detects the signal level of a harmonic included in a signal output from the transmitting circuit; a harmonic extracting circuit and a voltage control circuit that extract a harmonic from a modulated signal and adjust the harmonic so as to set the signal level less than or equal to a predetermined threshold. When being in the data non-transferring period, the transmitting circuit outputs a signal to the receiving circuit, the signal being generated by combining an amplified modulated signal with an under-adjustment signal.

### CROSS-REFERENCE TO RELATED APPLICATIONS

This application is based upon and claims the benefit of priority of the prior Japanese Patent Application No. 2010-240177, filed on Oct. 26, 2010, the entire contents of which are incorporated herein by reference.

### FIELD

The embodiments discussed herein are directed to a communication device that reduces transmitted harmonics.

### BACKGROUND

In radio communication systems, because 2nd, 3rd, . . . , n-th harmonics of a target signal transmitted may cause radio disturbance, radio laws and specifications of applied systems, etc., set a limit on the amount of harmonics transmitted. Therefore, in radio communication systems, various technologies have been studied to reduce harmonics.

For example, in a conventional radio communication system, in order to reduce harmonics output from both a quadrature modulator (QMOD) and a power amplifier (PA), a transmitter communication device arranges a lowpass filter (LPF) at a position downstream of the PA (first approach). In the above device, harmonics output from the QMOD is superposed on harmonics generated by the PA, then the superposed harmonics is reduced by using the LPF, and then a signal having the reduced harmonics is transmitted via an antenna.

There is another technology that enables a radio communication system to reduce harmonics transmitted (second approach). The circuit configuration used in the second approach is as follows. For example, a transmitter communication device separates a signal output from a QMOD into two and inputs one directly to a PA and the other to a bandpass filter (BPF), a phase shifter (PS), a variable gain amplifier (VGA), and then to the PA. The BPF is a circuit that extracts harmonics by attenuating a transmission signal; the PS is a circuit that varies the phase of harmonics according to a voltage control; and the VGA is a circuit that varies the gain of harmonics according to a voltage control. The above circuit configuration further needs a detector circuit (DET) that detects harmonics from an output signal of the PA and a voltage control circuit (Vcont) that adjusts the voltage of the PS and the voltage of the VGA so as to maintain a harmonic detection signal at its a lowest level. The Vcont adjusts the voltage of the PS and the voltage of the VGA so that a signal that is phase-shifted by the PS and gain-adjusted by the VGA may have a phase inverse to the phase of harmonics generated by the PA and an amplitude equal to the amplitude of harmonics generated by the PA, thereby reducing harmonics included in the transmission signal.
Patent document 1: Japanese Laid-open Patent Publication No. 58-14608

The communication device based on the above first approach has a problem in that the passband loss increases due to the harmonic-reducing LPF and the output level of the PA is increased to offset this loss, which leads to the current consumption being increased.

The communication device based on the above second approach has a problem in that, because of the necessity for a dedicated feedback circuit (detector circuit, etc.), the current consumption is increased.

### SUMMARY

According to an aspect of an embodiment of the invention, a communication device includes a transmitting unit that includes a quadrature modulator; a receiving unit that, when being in communication, demodulates a signal received from an external device and that, when being in a data non-transferring period, starts when power is switched on and ends when receiving operation starts, switches a local oscillator signal to a harmonic receiving signal, and detects a signal level of a harmonic included in a signal output from the transmitting unit; and a control unit that extracts a harmonic from a modulated signal that is output from the quadrature modulator and adjusts the harmonic so as to set the signal level less than or equal to a predetermined threshold. when being in the data non-transferring period, the transmitting unit outputs a signal to the receiving unit, the signal being generated by amplifying a modulated signal that is output from the quadrature modulator and by then combining the amplified signal with an under-adjustment signal that is output from the control unit, and when being in communication, the transmitting unit outputs a signal, the signal being generated by amplifying a modulated signal that is output from the quadrature modulator and by then combining the amplified signal with an adjusted signal that is output from the control unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic diagram of an example of the configuration of a communication device according to the first embodiment;

FIG. 2 is a schematic diagram of an example of the configuration of a communication device according to the second embodiment;

FIG. 3 is a flowchart of operation performed when being in a period that starts when the power is switched on and ends when normal receiving operation starts; and

FIG. 4 is a flowchart of normal communication operation.

### DESCRIPTION OF EMBODIMENTS

Preferred embodiments of the present invention will be explained with reference to accompanying drawings. The invention is not limited to the following embodiments.

### [a] First Embodiment

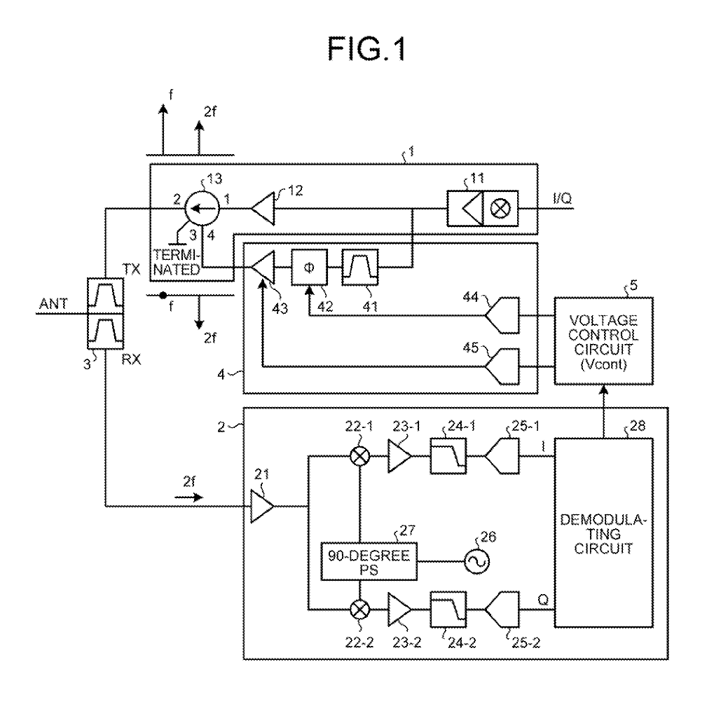

FIG. 1 is a schematic diagram of an example of the configuration of a communication device that can reduce harmonics transmitted according to the first embodiment. The communication device includes a transmitting circuit 1, a receiving circuit 2, a duplexer (DUP) 3, a harmonic extracting circuit 4, and a voltage control circuit (Vcont) 5. With the above communication device, when being in a receiving-circuit idle period that starts when the power is switched on and ends when receiving operation starts in normal communication, a given process is performed by using the existing receiving circuit to reduce a harmonic transmitted.

In the above communication device, the transmitting circuit 1 includes a digital modulator (QMOD) 11, a power amplifier (PA) 12, and a circulator (CIR) 13. The transmitting circuit 1 amplifies an output signal of the QMOD 11 by using the PA 12 and inputs the amplified signal to the port_1 of the CIR 13, and outputs, from the port_2, a synchronized signal that is generated by synchronizing the amplified signal with an output signal of the harmonic extracting circuit 4. The transmitting circuit 1 also outputs the output signal of the QMOD 11 to the harmonic extracting circuit 4. The digital modulator 11 used in the present embodiment is an IQ-plane-based quadrature modulator that outputs a quadrature-modulated wave. The CIR 13 is, for example, a four-port (terminal) circulator in which the port_3 is terminated and the port_4 inputs an output signal of the harmonic extracting circuit 4. The CIR 13 used in the present embodiment is merely an example and the CIR 13 can be a CIR having five or more ports.

The receiving circuit 2 includes a low noise amplifier (LNA) 21, two mixers (MIXs) 22-1 and 22-2, two automatic gain controllers (AGCs) 23-1 and 23-2, two lowpass filters (LPFs) 24-1 and 24-2, two analog-to-digital converters (ADCs) 25-1 and 25-2, a synthesizer (SYN) 26, a 90-degree phase shifter (90-degree PS) 27, and a demodulating circuit 28. The 90-degree PS 27 shifts one phase by 0 degree or maintains it unchanged and shifts the other phase by 90 degrees, divides each frequency into two; and outputs the divided signal. The receiving circuit 2 amplifies a received signal by using the LNA 21, separates the signal into two by using the LNA 21, and inputs one to the mixer 22-1 and the other to the mixer 22-2. The mixer 22-1 is driven by a signal output from the 90-degree PS 27, the signal being a phase-unchanged local oscillator signal (RXLO) of the SYN 26. The mixer 22-2 is driven by a signal output from the 90-degree PS 27, the signal being a 90°-phase-shifted local oscillator signal (RXLO) of the SYN 26. The mixer 22-1 outputs an output signal, via the AGC 23-1, the LPF 24-1, and the ADC 25-1, to the demodulating circuit (I signal input). The mixer 22-2 outputs an output signal, via the AGC 23-2, the LPF 24-2, and the ADC 25-2, to the demodulating circuit 28 (Q signal input). The demodulating circuit 28 always detects the level of the IQ signals when being in the receiving-circuit idle period that starts when the power is switched on and ends when receiving operation starts in normal communication and outputs the level of the IQ signals to the Vcont 5. The present embodiment enables reduction of a harmonic transmitted by using no dedicated circuit (e.g., a detector circuit, etc., that detects a harmonic) but the receiving circuit 2 that is an existing circuit of the communication device for normal communication. The receiving circuit 2 is an example of the quadrature demodulator (QDEM) operable in the present embodiment. So long as it is a quadrature demodulator, the configuration is not limited thereto.

The duplexer (DUP) 3 is a circuit that receives a transmission signal from the transmitting circuit 1 and then transmits it to an external device, and receives a signal from an external device and then outputs it to the receiving circuit 2. The receiver can receive a signal via the TX-RX path of the DUP 3 from the transmitter.

The harmonic extracting circuit 4 includes a bandpass filter (BPF) 41, a phase shifter (PS) 42, a variable gain amplifier (VGA) 43, a digital-to-analog converter (DAC) 44 for the PS 42, and a DAC 45 for the VGA 43. The BPF 41 extracts a desired harmonic (2f) by attenuating a main output signal (f) of the QMOD 11. The PS 42 and the VGA 43 vary, under later-described control of the Vcont 5, the phase and the gain of the harmonic received from the BPF 41. The harmonic extracting circuit 4 outputs a signal phase-adjusted by the PS 42 and gain-adjusted by the VGA 43 to the port_4 of the CIR 13.

The voltage control circuit (Vcont) 5 occasionally changes digital values set to the DACs 44 and 45 so as to maintain the IQ signals received from the demodulating circuit 28 at a lowest level. In accordance with occasional change of the digital values, the analog values output from the DACs 44 and 45 are changed, which enables control over the PS 42 and the VGA 43. In the present embodiment, whether the signal level is at the lowest is determined by using a threshold that becomes a reference value. More particularly, if the signal level is less than or equal to the predetermined threshold, the Vcont 5 determines that the signal level is at the lowest.

Operation of the communication device having the above configuration is described below with reference to FIG. 1. In the following example of the present embodiment, a second harmonic is reduced.

After the power is on, the transmitting circuit 1 inputs a predetermined harmonic detecting transmission data to the QMOD 11. The QMOD 11 modulates data in a predetermined manner and outputs an output signal. The transmitting circuit 1 separates the output signal of the QMOD 11 into two and outputs one to the PA 12 and the other to the BPF 41 of the harmonic extracting circuit 4. The PA 12 amplifies the output signal of the QMOD 11 and outputs the amplified signal to the port_1 of the CIR 13. The BPF 41 attenuates the main output signal of the QMOD 11, extracts, for example, the second harmonic, and outputs the extracted second harmonic to the PS 42.

The PS 42 and the VGA 43 adjust, under control of the Vcont 5, the phase and the gain of a received signal. More particularly, the Vcont 5 first sets the default values (digital values) to the DACs 44 and 45 and then changes, in accordance with the level of the IQ signals acquired from the demodulating circuit 28, the digital values set to the DACs 44 and 45. With this configuration, in accordance with the variable analog signals output from the DACs 44 and 45, the PS 42 adjusts the phase and the VGA 43 adjusts the gain. The VGA 43 outputs the phase-adjusted and gain-adjusted signal to the port_4 of the CIR 13.

The CIR 13 combines the signal that is phase-adjusted by the PS 42 and gain-adjusted by the VGA 43 with the signal that is amplified by the PA 12 and outputs the synthesized signal from the port_2.

In order to receive the second harmonic included in, for example, the synthesized signal coming through the TX-RX path of the DUP 3, the receiving circuit 2 switches the RXLO to a second harmonic receiving RXLO. The demodulating circuit 28 detects the level of the IQ signals corresponding to the second harmonic and outputs the level of the IQ signals to the Vcont 5.

The Vcont 5 changes, in accordance with the change in the level of the IQ signals received from the demodulating circuit 28, the digital values set to the DACs 44 and 45 so as to maintain the IQ signals at a lowest level, thereby controlling the PS 42 and the VGA 43. For example, the Vcont 5 performs the voltage control in such a manner that the second harmonic extracted by the BPF 41 from the divided output of the QMOD 11 and then adjusted by the PS 42 and the VGA 43 has a phase inverse to the phase of the harmonic generated by the PA 12 and an amplitude equal to the amplitude of the harmonic generated by the PA 12. Thus, the communication device according to the present embodiment outputs the second harmonic eliminated (reduced) transmission signal.

The Vcont 5 fixes the setting values (digital values) of the DACs 44 and 45 to the values that enable the IQ signals to be at a lowest level.

The communication device of the present embodiment performs the above process when the receiving circuit 2 is in the idle period that starts when the power is switched on and ends when the receiving circuit 2 starts operating for normal communication and, after normal communication starts, always makes second harmonic eliminated (reduced) communication.

As described above, in the present embodiment, when being in the period that starts when the power is switched on and ends when the receiving circuit 2 starts operating for normal communication, a process for reducing the harmonic transmitted is performed by using the existing receiving circuit 2 that is in an idle state. With this configuration, because a dedicated circuit (detector circuit, etc.) that operates as harmonic feedback is not needed, an increase in the current consumption is prevented.

Moreover, in the present embodiment, no LPF is provided at a position downstream of the PA to reduce the harmonic output from the QMOD. With this arrangement, because it is unnecessary to increase the output level of the PA, the main cause of an increase in the current disappears and, therefore, an increase in the current consumption is prevented.

Although, in the present embodiment, the second harmonic is reduced, it is possible to reduce any of the third, the forth, . . . , and the n-th harmonics. If any of the third, the forth, . . . , and the n-th harmonics are to be reduced, a filter capable of extracting the third, the forth, . . . , or the n-th harmonic is used as the BPF 41 and the RXLO is switched in accordance with the third, the forth, . . . , or the n-th harmonic.

### [b] Second Embodiment

The second embodiment achieves more effective the current consumption reduction using the circuit configuration of the communication device described in the first embodiment.

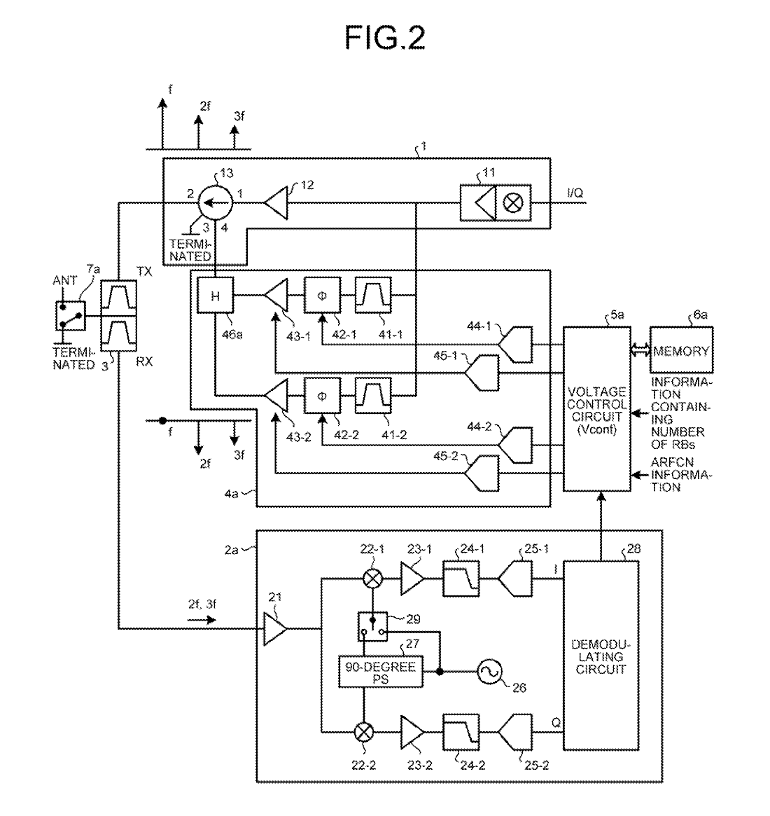

FIG. 2 is a schematic diagram of an example of the configuration of a communication device that can reduce harmonics transmitted according to the second embodiment. The communication device includes the transmitting circuit 1, a receiving circuit 2a, the duplexer (DUP) 3, a harmonic extracting circuit 4a, a voltage control circuit (Vcont) 5a, a memory 6a, and a switch (SW) 7a. With the communication device, when being in a receiving-circuit idle period that starts when the power is switched on and ends when receiving operation starts in normal communication, a given process is performed by using the existing receiving circuit to reduce a harmonic transmitted.

A radio specification of the communication device according to the present embodiment and a radio specification of a radio communication system that includes the communication device according to the present embodiment are described below.

The communication device of the present embodiment is based on, for example, the LTE that is a next-generation cell-phone system and uses SC-FDMA for an up-link of the LTE. In the SC-FDMA, an up-link transmission is performed based on RBs (Resource Blocks). The RB is a basic unit (1 RB is 180 kHz) of the up-link transmission. As changing the number of RBs from the minimum number 1 to the maximum number that is set in accordance with the channel bandwidth (CBW), the communication device of the present embodiment performs communication, while maintaining the average output power at a fixed value.

Moreover, the radio specifications of “3GPP TS 36.101” sets a limit on the LTE spurious emissions to −30 dBm and the resolution bandwidth (RBW) of a spectrum analyzer under a test to 1 MHz. These limits are the same as those by UMTS specifications “TS 25.101”; however, when a small number of RBs are transmitted in the LTE, because the bandwidth of harmonics becomes narrow as the number of RBs decreases, the limits are more difficult to be satisfied than the limits are satisfied under the UMTS having a wider usable bandwidth (3.84 MHz). For example, when a small number of RBs are transmitted in the LTE (e.g., five or less RBs are transmitted), because harmonics are concentrated within the RBW (1 MHz), the degree of difficulty in achieving the spurious emissions limit −30 dBm is higher than the degree of difficulty under the UMTS.

More particularly, as it is calculated by using the following equation (1), the energy of a UMTS second harmonic is distributed to about one seventh in a bandwidth of 7.68 MHz. In contrast, as it is calculated by using the following equation (2), when 1 RB is transmitted in the LTE, the bandwidth of a second harmonic becomes the narrowband of 360 kHz and the second harmonic is concentrated within the RBW. The UMTS achieves the spurious emission limit −30 dBm in the bandwidth of 7.68 MHz. In contrast, when 1 RB is transmitted, the LTE achieves the spurious emission limit −30 dBm in the bandwidth of 360 kHz.

The bandwidth of the UMTS second harmonic:

2×3.84 MHz=7.68 MHz (1)

The bandwidth of the LTE second harmonic (1 RB transmission):

2×180 kHz=360 kHz(within RBW(1 MHz)) (2)

The communication device of the present embodiment achieves more effective the current consumption reduction, satisfying the above radio specifications. The configuration of the communication device of the second embodiment is described in details below. The same components as those included in the communication device of the first embodiment are denoted with the same reference numerals and the same description is not repeated.

In the communication device of the present embodiment, the receiving circuit 2a includes not only the units of the receiving circuit 2 of the first embodiment but also a switch (SW) 29. The SW 29 is arranged between the MIX 22-1 and the 90-degree PS 27. The receiving circuit 2a connects, when being in normal communication, the MIX 22-1 and the 90-degree PS 27. In contrast, when being in the period, starts when the power is switched on and ends when the receiving circuit 2a starts operating for normal communication, the MIX 22-1 is connected to the SYN 26. Although the SW 29 can be arranged between the MIX 22-2 and the 90-degree PS 27, in the following example of the present embodiment, the SW 29 is at the MIX 22-1 side. It is noted that, when being in the period, starts when the power is switched on and ends when the receiving circuit 2a starts operating for normal communication, the MIX 22-2, the AGC 23-2, the LPF 24-2, the ADC 25-2, and the 90-degree PS 27 are in the idle state (power-saved operation).

The harmonic extracting circuit 4a includes, for example, two systems of circuit components of the first embodiment, thereby extracting, for example, both the second harmonic (2f) and the third harmonic (3f). The first system that can extract the second harmonic includes a BPF 41-1, a PS 42-1, a VGA 43-1, a DAC 44-1, and a DAC 45-1. The second system that can extract the third harmonic includes a BPF 41-2, a PS 42-2, a VGA 43-2, a DAC 44-2, and a DAC 45-2. A hybrid 46a combines an output of the first system with an output of the second system and outputs the synthesized signal. Each system has the corresponding components of the BPF 41, the PS 42, the VGA 43, the DAC 44, and the DAC 45 of the first embodiment.

The voltage control circuit (Vcont) 5a occasionally changes digital values set to each DAC so as to maintain the level of an I signal or the level of a Q signal (hereinafter, in the present embodiment “I signal level”) received from the demodulating circuit 28 at the lowest. When the I signal level or the Q signal level (in the present embodiment “I signal level”), is at the lowest, the Vcont 5a stores the current setting digital values of each DAC in the memory 6a and, at the same time, initializes the setting digital values of each DAC to the default value. During normal communication, if the number of RBs is small (if, in the present embodiment, the number of RBs is, for example, five or less, the number is determined to be small. If six or more, the number is determined to be large), the Vcont 5a reads the stored digital values from the memory 6a and sets the respective DACs to the digital values. In the present embodiment, whether the signal level is at the lowest is determined using, for example, a threshold that becomes a reference value in the same manner as in the first embodiment. More particularly, if the signal level is less than or equal to the predetermined threshold, the Vcont 5a determines that it is at the lowest.

The switch 7a switches so that the DUP 3 may be connected to either the antenna (ANT) side or the terminal side. During the period that starts when the power is switched on and ends when the receiving circuit 2a starts operating for normal communication, the DUP 3 is connected to the terminal side. During normal communication, the DUP 3 is connected to the antenna side.

The basic operation of the communication device having the above configuration is described below with reference to FIG. 2. In the following example of the present embodiment, both the second harmonic and the third harmonic are reduced. Although, in the present embodiment, first a process for reducing the second harmonic is performed and then a process for reducing the third harmonic is performed, it is possible to perform the process for reducing the third harmonic prior to the process for reducing the second harmonic. In the receiving circuit 2a, after the power is switched on, the SW 29 connects the MIX 22-1 to the SYN 26. When the MIX 22-1 is connected to the SYN 26, the MIX 22-2, the AGC 23-2, the LPF 24-2, the ADC 25-2, and the 90-degree PS 27 are in the idle state. After the power is switched on, in order to block out unnecessary radiation coming from the antenna, the SW 7a is connected to the terminal side.

After the power is switched on, the QMOD 11 of the transmitting circuit 1 receives the predetermined small-number-of-RB transmission data. When the QMOD 11 performs a modulating process in a predetermined manner, the transmitting circuit 1 separates an output signal of the QMOD 11 into two and outputs one to the PA 12 and the other to the BPF 41-1 of the harmonic extracting circuit 4a. The PA 12 amplifies the output signal of the QMOD 11 and outputs the amplified signal to the port_1 of the CIR 13. The BPF 41-1 attenuates the main output signal of the QMOD 11, extracts the second harmonic, and outputs the extracted second harmonic to the PS 42-1.

The PS 42-1 and the VGA 43-1 adjust, under control of the Vcont 5a, the phase and the gain of a received signal. The Vcont 5a first sets the default values (digital values) to the DACs 44-1 and 45-1 and then changes, in accordance with the I signal level acquired from the demodulating circuit 28, the digital values set to the DACs 44-1 and 45-1. With this configuration, in accordance with the variable analog signals output from the DACs 44-1 and 45-1, the PS 42-1 adjusts the phase and the VGA 43-1 adjusts the gain. The VGA 43-1 outputs the phase-adjusted and gain-adjusted signal to the port_4 of the CIR 13 via the hybrid 46a.

The CIR 13 combines the signal that is phase-adjusted by the PS 42-1 and gain-adjusted by the VGA 43-1 with the signal that is amplified by the PA 12 and outputs the synthesized signal from the port_2.

In order to receive the second harmonic included in, the synthesized signal coming through the TX-RX path of the DUP 3, the receiving circuit 2a switches the RXLO to a second harmonic receiving RXLO. The demodulating circuit 28 detects the I signal level corresponding to the second harmonic and outputs the I signal level to the Vcont 5a.

The Vcont 5a changes, in accordance with the change in the I signal level received from the demodulating circuit 28, the digital values set to the DACs 44-1 and 45-1 so that the I signal level may maintain at the lowest, thereby controlling the PS 42-1 and the VGA 43-1. For example, the Vcont 5a performs the voltage control in such a manner that the second harmonic extracted by using the BPF 41-1 and then adjusted by the PS 42-1 and the VGA 43-1 has a phase inverse to the phase of the harmonic generated by the PA 12 and an amplitude equal to the amplitude of the harmonic generated by the PA 12.

The Vcont 5a stores in the memory 6a the setting values (digital values) of the DACs 44-1 and 45-1 that enable the I signal level to be at the lowest. If the number of RBs is small in normal communication, the stored setting values are used as the setting values that enable reduction of the second harmonic. In parallel to the above storing process, the setting values of the DACs 44-1 and 45-1 are set back to the default values. In the present embodiment, when the process of storing the setting values that enable reduction of the harmonic is completed, a process is repeatedly performed by using the second system to process the third harmonic in the same manner. The Vcont 5a stores in the memory 6a the setting values (digital values) of the DACs 44-2 and 45-2 that enable the I signal level to be at the lowest. The setting values of the DACs 44-1 and 45-1 are set back to the default values. The SW 29 then connects the MIX 22-1 to the 90-degree PS 27.

When the processes of storing in the memory 6a the setting values that enables reduction of the second harmonic and the third harmonic are completed and then the SW 29 connects the MIX 22-1 to the 90-degree PS 27, the communication device of the present embodiment connects the SW 7a to the antenna side and starts normal communication.

When normal communication starts, the Vcont 5a reads information containing the number of RBs that has been acquired from, for example, a base station. Only if the number of RBs is small, the Vcont 5a activates the harmonic extracting circuit 4a (the harmonic extracting circuit 4a is always in the idle state except for this situation), reads all the stored setting values from the memory 6a, and sets the respective setting values to the DACs. Under the above situation, from the first system that includes the BPF 41-1, the PS 42-1, the VGA 43-1, the DAC 44-1, and the DAC 45-1, a signal is output, which is generated by extracting the second harmonic from the QMOD 11 and then phase-adjusting and gain-adjusting the extracted second harmonic. On the other hand, from the second system that includes the BPF 41-2, the PS 42-2, the VGA 43-2, the DAC 44-2, and the DAC 45-2, a signal is output, which is generated by extracting the third harmonic from the QMOD 11 and then phase-adjusting and gain-adjusting the extracted third harmonic. The hybrid 46a then combines the signal output from the first system with the signal output from the second system and outputs the synthesized signal to the transmitting circuit 1. The transmitting circuit 1 offsets the second harmonic and the third harmonic generated by the PA 12 using the synthesized signal and outputs the harmonics reduced signal. Thus, via the antenna of the communication device of the present embodiment, the harmonics reduced signal is transmitted.

If the number of RBs is large, the harmonic extracting circuit 4a maintains the idle state; therefore, the transmitting process is performed only by the transmitting circuit 1.

Two types of current consumption reducing operations are described below with reference to flowcharts in the chronological order: one operation is performed when being in the period that starts the power is switched on and ends when normal receiving operation starts and the other operation is performed when being in normal communication. In the present embodiment, for the sake of simplicity, the setting values that enable reduction of the second harmonic are stored first, and then the setting values that enable reduction of the third harmonic are stored.

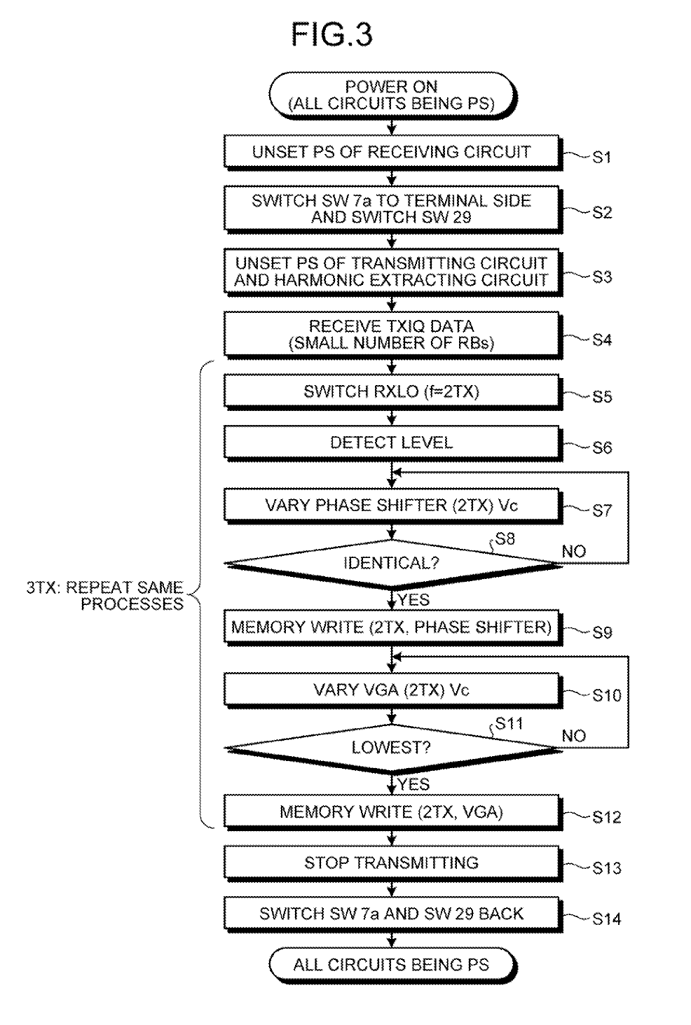

FIG. 3 is a flowchart of operation performed when being in the period that starts when the power is switched on and ends when normal receiving operation starts. In the communication device of the present embodiment, all circuits are in the idle state (power save operation). After the power is switched on, the communication device unsets the idle state of the receiving circuit 2a (S1). It is noted that, at S1, the MIX 22-2, the AGC 23-2, the LPF 24-2, the ADC 25-2, and the 90-degree PS 27 maintain in the idle state. The communication device of the present embodiment connects the SW 7a to the terminal side and the SW 29 connects the MIX 22-1 to the SYN 26 (S2). After that, the communication device of the present embodiment unsets the idle state of the transmitting circuit 1 and the harmonic extracting circuit 4a (S3).

The QMOD 11 then receives a predetermined small-number-of-RB transmission data (TXIQ data) (S4). At S4, the DACs 44-1 and 45-1 are set to the default values. In order to receive the second harmonic coming through the TX-RX path of the DUP 3, the receiving circuit 2a switches the RXLO to a second harmonic receiving RXLO (f=2TX) (S5).

When, under the above situation, the transmitting circuit 1, the harmonic extracting circuit 4a, and the receiving circuit 2a perform the predetermined respective operations, the Vcont 5a receives a first I signal level from the demodulating circuit 28 (S6). After that, the Vcont 5a changes, in accordance with a change in the I signal level received from the demodulating circuit 28, the digital value of the DAC 44-1, thereby controlling the PS 42-1 (S7 and No at S8). In other words, the Vcont 5a controls the phase of the second harmonic extracted by using the QMOD 11. When the phase becomes identical and the I signal level decreases to a predetermined threshold or lower (Yes at S8), the Vcont 5a stores in the memory 6a the current setting value of the DAC 44-1 (S9). The Vcont 5a then changes the digital value set to the DAC 45-1, thereby controlling the VGA 43-1 (S10 and No at S11). In other words, the Vcont 5a controls the gain of the phase identical signal. When the I signal level becomes the lowest (Yes at S11), the Vcont 5a stores in the memory 6a the current setting value of the DAC 45-1 (S12).

Thereafter, the above processes from S5 to S12 (f=3TX) are repeated to process the third harmonic and the setting values of the DACs 44-2 and 45-2 are stored in the memory 6a.

After the above processes from S5 to S12 are performed and the third harmonic is processed, the transmitting circuit 1 stops the transmitting process (S13). The communication device of the present embodiment then connects the SW 7a to the antenna side and the SW 29 connects the MIX 22-1 to the 90-degree PS 27 (S14), and all circuits are then in the idle state.

As described above, in the present embodiment, when being in the period that starts when the power is switched on and ends when receiving operation starts in a normal communication, the process is performed by using the existing receiving function to reduce the harmonics transmitted, which reduces the current consumption. Moreover, because part of the receiving circuit is in the idle state, more effective current consumption reduction is achieved.

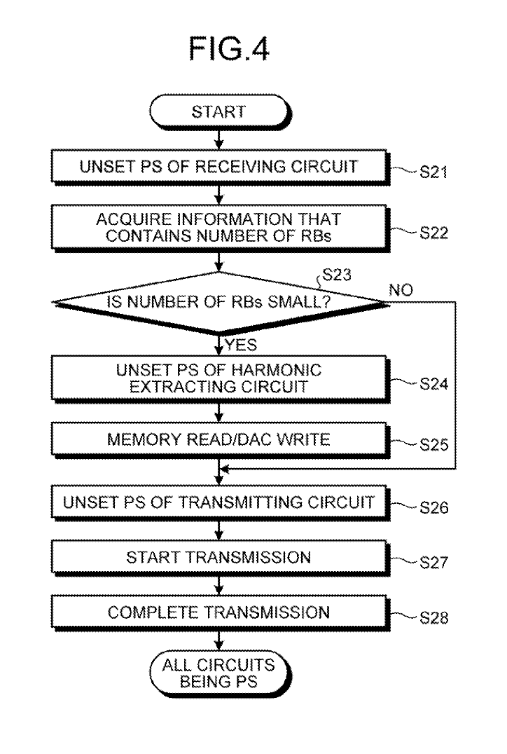

FIG. 4 is a flowchart of normal communication operation. In the communication device of the present embodiment, all circuits are in the idle state. After normal communication starts and the idle state of the receiving circuit 2a is then unset (S21), the Vcont 5a acquires the information that contains the number of RBs (S22).

If the Vcont 5a checks the information that contains the number of RBs and determines that the number of RBs is large (six or more) (No at S23), the communication device of the present embodiment unsets the idle state of the transmitting circuit 1 (S26).

On the other hand, if the Vcont 5a checks the information that contains the number of RBs and determines that the number of RBs is small (five or less), the communication device of the present embodiment unsets the idle state of the harmonic extracting circuit 4a (S24). The Vcont 5a reads, from the memory 6a, all the setting values that enable reduction of the second harmonic and the third harmonic and sets the setting values to the respective DACs (S25). After that, the communication device of the present embodiment unsets the idle state of the transmitting circuit 1 (S26).

Under the above situation, the communication device of the present embodiment starts normal transmission (S27). When the transmission is completed (S28), the communication device sets all circuits to the idle state, again.

As described above, in the present embodiment, only when the number of RBs is small, the harmonic extracting circuit 4a is activated. When the number of RBs is large, the harmonic extracting circuit 4a is in the idle state. This reduces the current consumption.

As described above, in the present embodiment, when being in the period that starts the power is switched on and ends when receiving operation starts in normal communication, the setting values that enable reduction of the transmitted harmonics are stored. During the normal communication, only when the number of RBs is small, the harmonic extracting circuit 4a is activated. With this configuration, even if SC-FDMA is used for LTE up-links, as the first embodiment has the same effect, an increase in the current consumption is prevented.

Moreover, in the present embodiment, only when the number of RBs is small, the harmonic extracting circuit 4a is activated. When the number of RBs is large, the harmonic extracting circuit 4a is in the idle state. This makes it possible to use identically configured radio circuits as a radio circuit for the UMTS and a radio circuit for the LTE. In other words, the device configuration satisfies the strict 3GPP specifications. Moreover, because the harmonic extracting circuit 4a is in the idle state when the number of RBs is large, more effective current consumption reduction is achieved.

Although the present embodiment provides two systems of circuit components that can extract both the second harmonic and the third harmonic, the configuration is not limited thereto. It is allowable to provide three or more systems of the circuit components or to extract an n-th harmonic (n is an arbitrary number).

If the harmonic has frequency characteristics, the Vcont 5a can be configured to further acquire ARFCN information and repeat the above processes from S5 to S12 on the channel position basis (e.g., L/M/H channel basis). The process is described with reference to, for example, FIG. 3. Firstly, the communication device of the present embodiment repeats the process of storing the setting value that enables reduction of the second harmonic, three times at positions L, M, and H, respectively. Then, the communication device of the present embodiment repeats the process of storing the setting value that enables reduction of the third harmonic, three times at positions L, M, and H, respectively. Thus, the process is repeated six times in total.

Although, in the present embodiment, in order to have the most effective current consumption reduction, when being in the period that starts the power is switched on and ends when receiving operation starts in normal communication, the process of storing a setting value that enables reduction of the harmonic transmitted is performed, the configuration is not limited thereto. If, for example, characteristics of the harmonic change depending on a change in the temperature or a change in the power-supply voltage, it is allowable to correct the setting value during normal communication when the communication slot is OFF, i.e., the receiving circuit is in the idle state. This makes it possible to maintain good characteristics.

Although, in the present embodiment for the sake of simplicity, the number of RBs is determined to be small if the number is five or less, the criterion is not limited thereto. For example, whether the number of RBs is small or large is determined appropriately on the basis of radio specifications (spurious emissions limits).

Moreover, it is allowable to apply the switch 7a of the second embodiment to the communication device of the first embodiment. Furthermore, in the first embodiment, it is allowable to use the receiving circuit 2a of the second embodiment instead of the receiving circuit 2.

According to an aspect of the communication device disclosed herein, it is possible to prevent an increase in the current consumption.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a transmitting unit that includes a quadrature modulator;
a receiving unit that, when being in communication, demodulates a signal received from an external device and that, when being in a data non-transferring period, starts when power is switched on and ends when receiving operation starts, switches a local oscillator signal to a harmonic receiving signal, and detects a signal level of a harmonic included in a signal output from the transmitting unit; and
a control unit that extracts a harmonic from a modulated signal that is output from the quadrature modulator and adjusts the harmonic so as to set the signal level less than or equal to a predetermined threshold, wherein
when being in the data non-transferring period, the transmitting unit outputs a signal to the receiving unit, the signal being generated by amplifying a modulated signal that is output from the quadrature modulator and by then combining the amplified signal with an under-adjustment signal that is output from the control unit, and
when being in communication, the transmitting unit outputs a signal, the signal being generated by amplifying a modulated signal that is output from the quadrature modulator and by then combining the amplified signal with an adjusted signal that is output from the control unit.

2. The communication device according to claim 1, wherein the control unit includes
a voltage control unit that controls a voltage so as to set the signal level to be less than or equal to the predetermined threshold,
a harmonic extracting/adjusting unit that includes a phase shifter and a variable gain controller and adjusts, in accordance with the voltage controlled by the voltage control unit, a phase and a gain of a harmonic that is extracted from a modulated signal that is output from the quadrature modulator, wherein
the voltage control unit stores, in a memory, a value that corresponds to a voltage value that enables the signal level to be at the predetermined threshold or lower and, when being in communication, reads the value from the memory and controls a voltage based on the value, and
the harmonic extracting/adjusting unit outputs a signal that is phase-adjusted and gain-adjusted in accordance with a voltage controlled based on the value.

3. The communication device according to claim 2, wherein
when being in communication, the harmonic extracting/adjusting unit is in an idle state for periods other than a period when voltage control is performed based on the value, and
when the harmonic extracting/adjusting unit is in the idle state, the transmitting unit outputs a signal that is generated by amplifying a modulated signal that is output from the quadrature modulator.

4. The communication device according to claim 2, wherein whether the value is read from the memory is determined depending on the number of resource block used for up-link transmission.

5. The communication device according to claim 1, wherein
the receiving unit performs a process of detecting the signal level of the harmonic by using a signal received from the transmitting unit via a TX-RX terminal of a duplexer, and
when being in the data non-transferring period, an antenna terminal of the duplexer is terminated.

6. The communication device according to claim 1, wherein the receiving unit detects, by using either a signal of an I channel or a signal of a Q channel, the signal level of the harmonic and sets the channel that is not used for level detection to be in an idle state.

7. An transmitted harmonic reducing method performed by a communication device that includes a transmitting unit that includes a quadrature modulator and a receiving unit that demodulates a signal received from an external device, the method comprising:
when being in a data non-transferring period, starts when power is switched on and ends when receiving operation starts,
switching, by the receiving unit, a local oscillator signal to a harmonic receiving signal and detecting a signal level of a harmonic included in a signal output from the transmitting unit; and
extracting, by a control unit, a harmonic from a modulated signal output from the quadrature modulator and adjusting the harmonic so as to set the signal level less than or equal to a predetermined threshold, wherein
the transmitting unit outputs a signal to the receiving unit, the signal being generated by amplifying a modulated signal that is output from the quadrature modulator and by then combining the amplified signal with an under-adjustment signal that is output from the control unit, and
when being in communication, the transmitting unit outputs a signal, the signal being generated by amplifying a modulated signal that is output from the quadrature modulator and by then combining the amplified signal with an adjusted signal that is output from the control unit.
